(19) United States
(12) Patent Application Publication
(10) Pub. No.: US 2015/0223302 A1
(43) Pub. Date: Aug. 6, 2015

(54) LIGHTING COLOR CONTROL METHOD AND SYSTEM

(71) Applicants: Dror Manor, Herzliya (IL); Shafrir Romano, Rishon LeTzion (IL)

(72) Inventors: Dror Manor, Herzliya (IL); Shafrir Romano, Rishon LeTzion (IL)

(21) Appl. No.: 14/215,098

(22) Filed: Mar. 17, 2014

Related U.S. Application Data
(60) Provisional application No. 61/935,874, filed on Feb. 5, 2014.

(51) Int. Cl. H05B 33/08; H05B 37/02

(52) U.S. Cl. CPC H05B 33/0857; H05B 37/0272; H05B 37/0227

(57) ABSTRACT

A method, apparatus and system for controlling lighting color are disclosed, wherein a lighting assembly is provided, comprising first and second lighting sources of different colors interconnected in opposite polarity directions. The lighting color control method comprises the step of applying a bipolar driving signal to the lighting assembly, thereby alternately driving the first and second lighting sources for achieving a lighting color, in particular a lighting temperature, respective to the polarity ratio of the bipolar driving signal.

### FIELD OF THE INVENTION

The present invention relates generally to lighting systems, and more particularly to methods and systems for controlling lighting color.

### BACKGROUND OF THE INVENTION

Light Emitting Diodes (LED)s have become a prevailing technology in the industry of lighting. A common technique known in the art to control LED lighting color comprises using three LEDs of different basic colors, typically red, green and blue. An LED driver then changes the proportion of the lighting intensities between the individual LEDs, typically in response to a remote command, so as to adjust the overall lighting color to a desired one.

A common version of the above technique comprises an LED pair assembly, typically one yellow-white colored LED and the one noon-daylight colored LED. Upon changing the relative intensities in this case, the overall lighting temperature of the assembly can be adjusted between about 3000 Kelvin-deg of the yellow-white LED to about 5500 Kelvin-deg of the noon-daylight LED. However, a minimum of three wires are needed in the above examples between the LED driver and the LED pair assembly, which complicates wiring installation, especially when an existing wiring installation has to be reused.

Thus, it would be desirable to achieve a variable color/temperature lighting solution that resorts to only two wires connecting the lighting driver and the LED pair assembly.

### SUMMARY OF THE INVENTION

Accordingly, it is a principal object of the present invention to provide improved methods and systems of variable color/temperature lighting comprising two wire connection between the lighting driver and lighting source assembly. Thus, in accordance with an embodiment of the present invention, a method of controlling lighting color is disclosed, wherein a lighting assembly is provided comprising first and second lighting sources of different colors interconnected in opposite polarity directions. The lighting color control method comprises the steps of applying a bipolar driving signal to the lighting assembly, thereby alternately driving the first and second lighting sources, and determining an appropriate polarity ratio of the bipolar driving signal for achieving a desired lighting color, in particular lighting temperature, of the lighting assembly.

In an embodiment, the method further comprises the step of applying an activity duty cycle to the bipolar driving signal, for dimming the emitted light. This dimming is optionally determined according a dimming angle detected on an AC power line from which the bipolar driving signal is derived. In some embodiments, the detected dimming angle also affects the temperature of the lighting emitted by the lighting assembly.

In an embodiment, the method further comprises the step of remotely controlling the bipolar driving signal polarity ratio.

In some embodiments, each of the first and second lighting sources comprises one or more light emitting diode (LED) chains, wherein the chains within each of the lighting sources are connected in parallel and each chain comprises at least one LED.

In an embodiment, each of the first and second lighting sources comprises a reverse voltage protection means.

In an embodiment, the first lighting source is adapted to emit a yellow-white color and the second lighting source is adapted to emit a noon-daylight color.

In accordance with an embodiment of the present invention, there is also provided a lighting driver comprising a driving unit configured to drive a lighting assembly with a bipolar driving signal, and a control unit coupled to the driving unit and configured to set a polarity ratio of the bipolar driving signal for determining the color of lighting emitted by the lighting assembly.

In accordance with an embodiment of the present invention, there is also provided a lighting system comprising a lighting driver configured to produce a bipolar driving signal, and a lighting assembly comprising first and second lighting sources of different colors interconnected in opposite polarity directions and adapted to be alternately driven by the bipolar driving signal for affecting the color of lighting emitted by the lighting assembly corresponding to the bipolar driving signal polarity ratio.

### BRIEF DESCRIPTION OF THE DRAWINGS

The present invention will be more fully understood from the following detailed description of the embodiments thereof, taken together with the drawings in which:

FIG. 1 is a block diagram that schematically illustrates a lighting system comprising a lighting assembly and driver, in accordance with an embodiment of the present invention;

FIGS. 2A and 2B are waveform diagrams that schematically illustrate the operation of a lighting system comprising a lighting driver and lighting assembly, in accordance with an embodiment of the present invention; and

FIG. 3 is a flowchart that schematically illustrates a method of controlling lighting color, in accordance with an embodiment of the present invention.

### DETAILED DESCRIPTION OF EMBODIMENTS

Embodiments of the present invention provide lighting systems in which lighting color and temperature of an LED assembly can be adjusted without resorting to more than two wires for connecting the LED assembly to an LED driver. This is achieved due to bipolar driving signal drive of an LED pair interconnected within the LED assembly in opposite polarity directions, as detailed hereinafter.

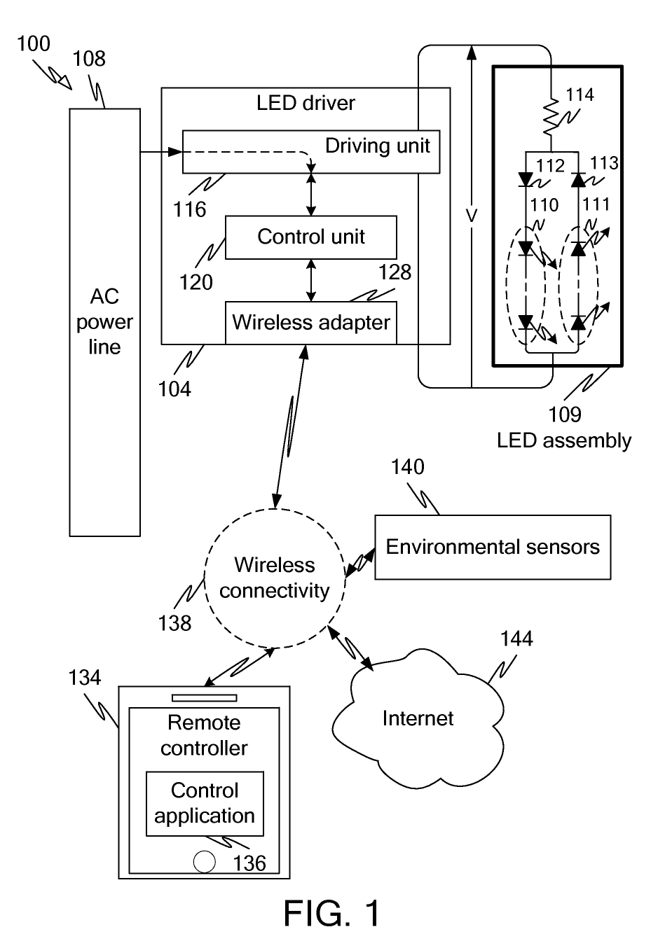

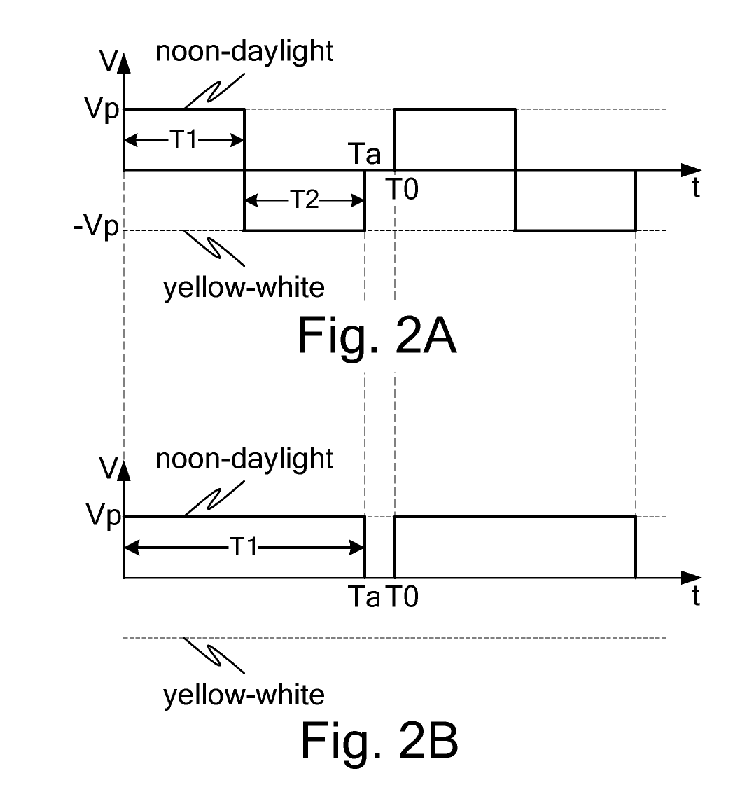

Referring to FIG. 1, there is shown a block diagram of a lighting system 100, in accordance with an embodiment of the present invention. In the figure, a lighting driver 104, which is an LED driver in an embodiment, is connected to an AC power line 108. LED driver 104 drives an LED assembly 109 through a two wire connection. Inside LED driver 104, there is shown a driving unit 116 which is fed from AC power line 108. In an embodiment driving unit 116 comprises a rectifier and a DC to AC converter, not detailed in FIG. 1. The converter output drives LED assembly 109 with a rectangular bipolar driving signal depicted by voltage V on LED assembly 109. The bipolar drive is further detailed in FIGS. 2A and 2B described below.

LED assembly 109 comprises first and second lighting sources 110 and 111 interconnected in opposite polarity directions, i.e. back-to-back. In this way, voltage V drives lighting sources 110 and 111 alternately. In embodiments of the present invention each lighting source comprises one or more LED chains connected in parallel, each comprising one or more LEDs. Only one LED chain per lighting source is depicted in FIG. 1 for the sake of simplicity.

In FIG. 1, the two lighting sources, i.e. LED chains 110 and 111 are of different colors, related two different color temperatures. In an embodiment, one chain consists of yellow-white LEDs having lighting temperature of about 3000 Kelvin-deg, while the other chain consists of noon-daylight LEDs having lighting temperature of about 5500 Kelvin-deg. In another embodiment, one chain consists of warm-white LEDs having lighting temperature of about 2700 Kelvin-deg, while the other chain consists of cool-white LEDs having lighting temperature of about 7500 Kelvin-deg.

Diodes 112 and 113 protect LED chains 110 and 111 respectively from reverse voltage breakdown. Resistor 114 determines the current flowing through LED chains 110 and 111 when driving unit 116 functions as an AC voltage source having a peak voltage Vp. In another embodiment, driving unit 116 functions as an AC current source having a peak current Ip, which obviates the need for resistor 114. In some embodiments, any applicable serial and parallel connectivity of multiple LED assemblies such as assembly 109 may be used.

A control unit 120, typically Pulse Width Modulation (PWM) based, controls driving unit 116. In an embodiment, control unit 120 may affect various operating parameters of lighting system 100 such as lighting color/temperature and lighting intensity/dimness, as described below. In an embodiment, control unit 120 also constantly senses whether the AC power received from AC power line 108 is affected by a phase cut dimmer, and detects the dimming angle in this case. This is depicted in FIG. 1 by a dashed line through driving unit 116. Control unit 120 then adjusts, through driving unit 116, the lighting intensity of LED assembly 109, respectively to the detected dimming angle. The details of this intensity adjustment are provided below. The term “control” is used hereinafter for “command” as well as for “monitoring”.

LED driver 104 also comprises a wireless adapter 128, thereby allowing remote control of driving unit 116 through wireless connectivity 138. In embodiments of the present invention, wireless adapter 128 may support various types of communication protocols such as Bluetooth, ZigBee and Wi-Fi.

In an embodiment, control unit 120 comprises a micro-processor which executes a program code that can manage wireless adapter 128, as well as interpret command and monitoring messages received from a remote location through wireless adapter 128. In an alternative embodiment, control unit 120 comprises a simple electronic circuit and needs wireless adapter 128 to convert between remote messages, at the wireless side of wireless adapter 128, and variable electrical levels at its controller side. In some alternative embodiments, control unit 120 is combined with LED driver 116. In an embodiment, when the lighting intensity of LED driver 104 is remotely controlled while it is fed through a phase cut dimmer, control unit 120 would prioritize the remotely commanded lighting intensity, provided that it is not too high relative to the lighting intensity implied from the dimming angle.

In embodiments of the present invention, various remote control means may communicate with LED driver 104 through wireless adapter 128. Some of those remote control means are shown in FIG. 1 and described herein. A remote controller 134, which may be a dedicated appliance or some universal remote controller, communicates with LED driver 104 through wireless connectivity 138. Remote controller 134 may be, for example, a smartphone that runs a control application 136. Environmental sensors 140 may provide control application 136 and/or control unit 120, with environmental data such as lighting level and detected motion in the vicinity of LED assembly 109. Control application 136 and/or control unit 120 may then affect the operation of driving unit 116 based on the environmental data. Other control means, not shown in FIG. 1, may communicate with any of the above described control means through the Internet, depicted as 144.

In another embodiment, wherein the AC power received from AC power line 108 is affected by a phase cut dimmer, control unit 120 adjusts the lighting temperature as well as the lighting intensity of LED assembly 109. This is done through driving unit 116, in accordance with the detected dimming angle. This is typically done based on an angle-to-temperature mapping table included in control unit 120. This mapping typically causes decrease of the lighting temperature, from maximum to minimum, respectively to the diming angle decrease from maximum to minimum. In an alternative embodiment, the lighting temperature increases from minimum to maximum, respectively to the diming angle decrease from maximum to minimum. The exact mechanism of lighting temperature control is described below.

The above description has focused on the specific elements of lighting system 100 that are essential for understanding certain features of the disclosed techniques. Conventional elements the system not needed for this understanding have been omitted from FIG. 1 for the sake of simplicity, but will be apparent to persons of ordinary skill in the art. The configuration shown in FIG. 1 is an example configuration, which was chosen purely for the sake of conceptual clarity. In alternative embodiments, any other suitable configurations can also be used.

FIG. 2A is a waveform diagram that schematically illustrates the operation of lighting system 100, in accordance with an embodiment of the present invention. The waveform relates to bipolar periodic AC voltage V that driving unit 116 applies to lighting assembly 109. In the figure, T0 denotes the period time of V. T1 is the period part in which V=Vp, hence LED chain 110 is conducting and emitting noon-daylight. T2 is the period part in which V=−Vp, hence LED chain 111 is conducting and emitting yellow-white light. Ta=T1+T2 is the period part in which LED assembly 109 is driven by driving unit 116, i.e. either LED chain 110 or LED chain 111 is emitting light. The ratio Ta/T0 constitutes an activity duty cycle, or a dimming factor, to which system 100 is adjusted. The ratio T1/Ta constitutes a polarity ratio of driving voltage V, which determines the lighting temperature to which system 100 is adjusted.

FIG. 2B is similar to FIG. 2A, save that the polarity ratio equals 1, instead of 0.5, hence lighting assembly 109 is emitting noon-daylight. When driving unit 116 functions as a current source, notations I and Ip shall be used instead of V and Vp respectively in FIGS. 2A and 2B above.

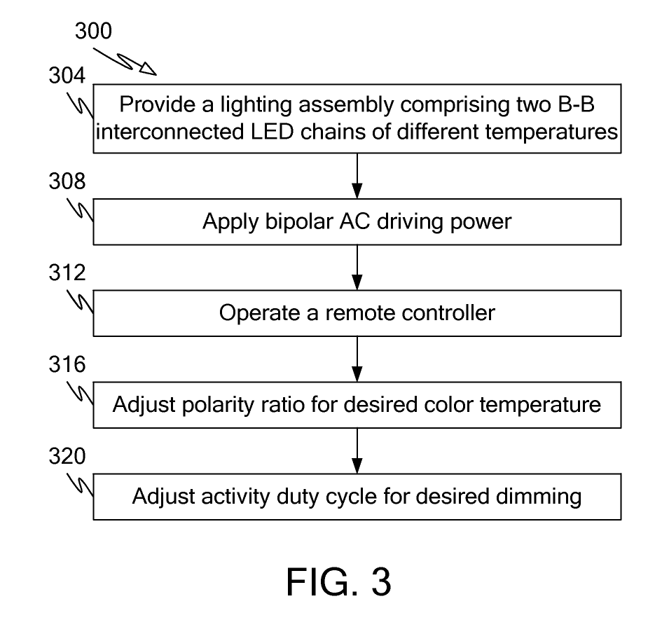

FIG. 3 shows a flowchart 300 which schematically illustrates a method of controlling lighting color, in accordance with an embodiment of the present invention. The method begins with a providing step 304, in which LED assembly 109 is provided, wherein two LED chains of different colors/temperatures are interconnected in opposite polarity directions. In an applying step 308 that follows, driving unit 116 applies a bipolar driving signal to lighting assembly 109. Next, in an operating step 312, remote controller 134 is operated, additively or alternatively to environmental sensors 140, for controlling LED driver 104, as explained above. In an adjusting step 316, control unit 120 adjusts the polarity ratio at the output of driving unit 116 for achieving a desired temperature of the light emitted by LED assembly 109. Flowchart 300 ends with an adjusting step 316, wherein control unit 120 adjusts the activity duty cycle at the output of driving unit 116 for achieving a desired dimming of the light emitted by LED assembly 109.

Flowchart 300 is an example flowchart, which was chosen purely for the sake of conceptual clarity. In alternative embodiments, any other suitable flowchart can also be used for illustrating the disclosed method. Method steps that are not mandatory for understanding the disclosed techniques were omitted from FIG. 3 for the sake of simplicity.

Although the embodiments described herein mainly address LED based lighting systems, the methods and systems exemplified by these embodiments can also be applied to other suitable lighting sources, as well as to other applications that may be suitably affected by variable polarity ratio of a bipolar driving signal drive.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

[symbol] riving signal.

1. A method of producing lighting, wherein a lighting assembly comprising first and second lighting sources of different colors interconnected in opposite polarity directions is provided, the method comprising the steps of
producing a bipolar driving signal for alternately driving the first and second lighting sources; and
determining a polarity ratio of the bipolar driving signal for achieving a desired color of the lighting emitted by the lighting assembly.

2. The method of claim 1, further comprising the step of applying an activity duty cycle to the bipolar driving signal, for dimming the emitted lighting.

3. The method of claim 1, further comprising the steps of:
sensing a dimming angle on an AC power line from which the bipolar driving signal is derived; and
adjusting the bipolar driving signal polarity ratio for having a desired lighting temperature associated with the achieved lighting color.

4. The method of claim 3, wherein adjusting the bipolar driving signal polarity ratio comprises decreasing the lighting temperature upon detecting a decrease of the sensed dimming angle.

5. The method of claim 3, wherein adjusting the bipolar driving signal polarity ratio comprises increasing the lighting temperature upon detecting a decrease of the sensed dimming angle.

6. The method of claim 1, further comprising the step of remotely controlling the bipolar driving signal polarity ratio.

7. The method of claim 1, wherein each of the first and second lighting sources comprises one or more light emitting diode (LED) chains, the chains within each of the lighting sources connected in parallel and each LED chain comprising at least one LED.

8. The method of claim 1, wherein each of the first and second lighting sources comprises a reverse voltage protection means.

9. The method of claim 1, wherein achieving the lighting color comprises achieving a corresponding lighting temperature.

10. The method of claim 1, wherein the first lighting source is adapted to emit light having a temperature in the range of 2500 Kelvin-degree to 3500 Kelvin-degree and the second lighting source is adapted to emit light having a temperature in the range of 5000 Kelvin-degree to 8000 Kelvin-degree.

11. A lighting driver comprising:
a driving unit configured to drive a lighting assembly with a bipolar driving signal; and
a control unit coupled to the driving unit and configured to set a polarity ratio of the bipolar driving signal for determining the color of lighting emitted by the lighting assembly.

12. The lighting driver of claim 11, wherein the control unit is combined with the driving unit.

13. The lighting driver of claim 11, wherein the control unit is further configured to apply an activity duty cycle to the bipolar driving signal, for dimming the lighting emitted by the lighting assembly.

14. The lighting driver of claim 13, wherein the control unit is further configured to sense a dimming angle of an AC power that feeds the lighting driver and to affect the activity duty cycle respectively to the sensed dimming angle.

15. The lighting driver of claim 11, wherein the control unit is further configured to sense a dimming angle of an AC power that feeds the lighting driver and to affect the bipolar driving signal polarity ratio respectively to the sensed dimming angle.

16. The lighting driver of claim 15, wherein the control unit is configured to affect the bipolar driving signal polarity ratio respectively to the sensed dimming angle so as to decrease the temperature of lighting emitted by the lighting assembly upon detecting a decrease of the sensed dimming angle.

17. The lighting driver of claim 15, wherein the control unit is configured to affect the bipolar driving signal polarity ratio respectively to the sensed dimming angle so as to increase the temperature of lighting emitted by the lighting assembly upon detecting a decrease of the sensed dimming angle.

18. The lighting driver of claim 11, further comprising a communication means adapted to receive wireless remote control for affecting, through the control unit, the bipolar driving signal polarity ratio.

19. The lighting driver of claim 11, wherein the lighting assembly comprises first and second lighting sources of different colors interconnected in opposite polarity directions and adapted to be alternately driven by the bipolar driving signal.

20. The lighting driver of claim 19, wherein each of the first and second lighting sources comprises one or more light emitting diode (LED) chains, the LED chains within each of the lighting sources connected in parallel and each of the LED chains comprising at least one LED.

21. The lighting driver of claim 11, wherein the control unit comprises pulse width modulation (PWM) control.

22. The lighting driver of claim 11, wherein the driving unit comprises a voltage source.

23. The lighting driver of claim 11, wherein the driving unit comprises a current source.

24. The lighting driver of claim 11, wherein achieving the lighting color comprises achieving a corresponding lighting temperature.

25. A lighting assembly comprising first and second lighting sources of different colors interconnected in opposite polarity directions and adapted to be driven by a bipolar driving signal for achieving a lighting color respective to the bipolar driving signal polarity ratio.

26. The lighting assembly of claim 25, each of the first and second lighting sources comprises one or more light emitting diode (LED) chains, the chains within each of the lighting sources connected in parallel and each LED chain comprising at least one LED.

27. The lighting assembly of claim 25, wherein each of the first and second lighting sources comprises a reverse voltage protection means.

28. The lighting assembly of claim 25, wherein achieving the lighting color comprises achieving a corresponding lighting temperature.

29. The lighting assembly of claim 25, wherein the first lighting source is adapted to emit light having a temperature in the range of 2500 Kelvin-degree to 3500 Kelvin-degree and the second lighting source is adapted to emit light having a temperature in the range of 5000 Kelvin-degree to 8000 Kelvin-degree.

30. A lighting system comprising
a lighting assembly comprising first and second lighting sources of different colors interconnected in opposite polarity directions and adapted to be alternately driven by the bipolar driving signal, and
a lighting driver configured to produce a bipolar driving signal and to set a polarity ratio of said bipolar driving signal so as to result in a desired color of the lighting emitted by the lighting assembly.

31. The lighting system of claim 30, wherein each of the first and second lighting sources comprises one or more light emitting diode (LED) chains, the LED chains within each of the lighting sources connected in parallel and each LED chain comprising at least one LED.

32. The lighting system of claim 30, wherein the lighting driver is also configured to apply an activity duty cycle to the bipolar driving signal, for dimming the lighting emitted by the lighting assembly.

33. The lighting system of claim 32, wherein the lighting driver is also configured to sense a dimming angle of an AC power that feeds the lighting driver and to affect the bipolar driving signal activity duty cycle respectively to the sensed dimming angle.

34. The lighting system of claim 30, wherein the lighting driver is also configured to sense a dimming angle of an AC power that feeds the lighting driver and to set the polarity ratio of said bipolar driving signal so as to result in a desired color of the lighting emitted by the lighting assembly by determining a desired lighting temperature associated with the lighting color.

35. The lighting system of claim 34, wherein the lighting driver is configured to determine the desired lighting temperature by decreasing the lighting temperature upon detecting a decrease of the sensed dimming angle.

36. The lighting system of claim 34, wherein the lighting driver is configured to determine the desired lighting temperature by increasing the lighting temperature upon detecting a decrease of the sensed dimming angle.

37. The lighting system of claim 30, wherein the lighting driver comprises a communication means adapted to receive remote control for affecting the bipolar driving signal polarity ratio.

38. The lighting system of claim 30, wherein the lighting driver comprises pulse width modulation (PWM) control.

39. The lighting system of claim 30, wherein the lighting driver comprises a voltage source for producing the bipolar driving signal.

40. The lighting system of claim 30, wherein the lighting driver comprises a current source for producing the bipolar driving signal.

41. The lighting system of claim 30, wherein achieving the lighting color comprises achieving a corresponding lighting temperature.

42. The lighting system of claim 30, wherein the first lighting source is adapted to emit light having a temperature in the range of 2500 Kelvin-degree to 3500 Kelvin-degree and the second lighting source is adapted to emit light having a temperature in the range of 5000 Kelvin-degree to 8000 Kelvin-degree.
